(19) United States
(12) Patent Application Publication
(10) Pub. No.: US 2024/0035433 A1
(43) Pub. Date: Feb. 1, 2024

(54) MODULAR RIM-DRIVE PUMP-TURBINE

(71) Applicant: THE PENN STATE RESEARCH FOUNDATION, University Park, PA (US)

(72) Inventors: Arnold FONTAINE, University Park, PA (US); Nicholas JAFFA, University Park, PA (US)

(21) Appl. No.: 18/039,843

(22) PCT Filed: Nov. 16, 2021
(86) PCT No.: PCT/US2021/059477

§ 371 Date: Jun. 1, 2023

Related U.S. Application Data
(60) Provisional application No. 63/120,475, filed on Dec. 2, 2020.

(51) Int. Cl. F03B 3/10; F01D 15/08; F03B 13/08

(52) U.S. Cl. CPC F03B 3/10; F01D 15/08; F03B 13/08

(57) ABSTRACT

Various implementations include a rim-drive turbomachine including a hollow cylindrical shell, at least one motor rotor, at least one motor stator, and two or more sets of blades. The shell includes two or more shell portions axially separate from, and couplable to, each of the other shell portions. Each motor rotor is coupled to the inner surface of a shell portion, extends circumferentially around the central axis, and is rotatable about the central axis. Each motor stator is in electromagnetic communication with one motor rotor. Each shell portion has at least one set of blades coupled to the inner surface of that shell portion. The blades of each set of blades extend radially inwardly toward the central axis and are spaced circumferentially around the central axis. The sets of blades are axially spaced apart along the central axis. A single set of blades is coupled to a motor rotor.

### CROSS-REFERENCE TO RELATED APPLICATIONS

This application claims the benefit of U.S. Provisional Patent Application No. 63/120,475, filed Dec. 2, 2020, the content of which is incorporated herein by reference in its entirety.

### BACKGROUND

Solar and wind provide inexpensive renewable energy resources and represent a significant and rapidly growing percentage of the total U.S. energy production. The intermittent nature of these renewable resources requires effective methods of energy storage. Currently, pumped storage hydropower (“PSH”) is the most common method of large energy storage but is limited by available sites (terrain with large easy-to-access reservoirs with large elevation changes). Currently, new PSH development has been limited by (1) uncertainty in return investment, (2) length of time to commissioning, (3) high initial and total capital costs, and (4) siting opportunities and available revenue streams. For PSH development to accelerate, there appear to be two general models for improved economic viability: (1) Large scale centralized and optimized PSH plants and (2) small scale distributed modular PSH plants.

Traditional PSH has followed the first model and has been aimed at very large scale (500 MW-1000 MW) and high-head pressure sites that operate on predictable daily variability in demand for power. This model requires the plants to be optimized for maximum efficiency and are tailored to the specific site. Given the large scale and large potential energy contained in the reservoir, these PSH plants are very capital intensive to build and can be risky with respect to uncertainty in pricing, environmental impact, and potential impact of failure.

Thus, there is a need for a PSH turbomachine that is simple, reliable, easy to install across a wide range of sites, scalable, modular, and economically attractive.

### SUMMARY

Various implementations include a rim-drive turbomachine. The turbomachine includes a hollow cylindrical shell, at least one motor rotor, at least one motor stator, and N sets of blades. The hollow cylindrical shell has an inner surface and a central axis. The shell includes S shell portions, wherein S equals two or more. Each of the S shell portions is axially separate from each of the other shell portions, and each of the S shell portions are axially couplable to the other shell portions. The at least one motor rotor is coupled to the inner surface of one of the S shell portions and extends circumferentially around the central axis. The at least one motor rotor is rotatable about the central axis and relative to the shell. The at least one motor stator is in electromagnetic communication with the at least one motor rotor. The N sets of blades equals two or more sets of blades. Each of the S shell portions has at least one of the N sets of blades coupled to the inner surface of that shell portion. Each of the N sets of blades extends radially inwardly toward the central axis. The blades of each of the N sets of blades are spaced circumferentially around the central axis. Each of the N sets of blades is axially spaced apart along the central axis from each of the other sets of blades. A single set of N blades is coupled to the at least one motor rotor.

In some implementations, each of the blades has an outer end coupled adjacent the inner surface and an inner end that is spaced radially inward of the outer end. The inner ends of the blades are spaced apart from the central axis and define an aperture through which the central axis extends.

In some implementations, one of the N sets of blades is stationary with respect to the shell.

In some implementations, the turbomachine further includes R motor rotors coupled to the inner surface of the shell and extending circumferentially around the central axis and R motor stators. Each of the R motor stators is in electromagnetic communication with one of the R motor rotors. One of the R motor rotors is rotatable relative to the shell, and the second set of blades is coupled to the second motor rotor. In some implementations, each of the R motor rotors is independently rotatable from the other motor rotors.

In some implementations, the one set of blades are shaped such that, when the one set of blades are rotated, the one set of blades causes a higher pressure of a fluid inside the shell adjacent the inner surface of the shell than adjacent the central axis.

In some implementations, the shell has an outer surface radially spaced apart from the inner surface, and the motor stator is coupled to the outer surface of the shell.

In some implementations, the shell is configured to be disposed within a pipe. In some implementations, the turbomachine is usable as a turbine. In some implementations, the turbomachine is usable as a pump.

In some implementations, S is equal to N.

Various other implementations include a rim-drive system. The system includes a rim-drive turbomachine, a first reservoir, and a second reservoir. The hollow cylindrical shell of the turbomachine has a central axis, a first end, a second end opposite and spaced apart along the central axis from the first end, and an inner surface extending between the first and second ends. The first reservoir is for containing fluid and is fluidically coupled to the first end of the shell. The second reservoir is for containing fluid and is fluidically coupled to the second end of the shell.

In some implementations, each of the blades has an outer end coupled adjacent the inner surface and an inner end that is spaced radially inward of the outer end. The inner ends of the blades are spaced apart from the central axis and define an aperture through which the central axis extends.

In some implementations, one of the N sets of blades is stationary with respect to the shell. In some implementations, the first reservoir is disposed at a higher altitude than the second reservoir, and the one set of blades that is stationary with respect to the shell is closer than the other sets of blades to the first end of the shell.

In some implementations, the turbomachine further includes R motor rotors coupled to the inner surface of the shell and extending circumferentially around the central axis and R motor stators. Each of the R motor stators is in electromagnetic communication with one of the R motor rotors. One of the R motor rotors is rotatable relative to the shell, and the second set of blades is coupled to the second motor rotor. In some implementations, each of the R motor rotors is independently rotatable from the other motor rotors.

In some implementations, the one set of blades are shaped such that, when the one set of blades are rotated, the one set of blades causes a higher pressure of a fluid inside the shell adjacent the inner surface of the shell than adjacent the central axis.

In some implementations, the shell has an outer surface radially spaced apart from the inner surface, and the motor stator is coupled to the outer surface of the shell.

In some implementations, the shell is configured to be disposed within a pipe. In some implementations, the turbomachine is usable as a turbine. In some implementations, the turbomachine is usable as a pump.

In some implementations, S is equal to N.

In some implementations, the system further includes a first pipe fluidically coupling the first reservoir to the first end of the shell. In some implementations, the system further includes a second pipe fluidically coupling the second reservoir to the second end of the shell.

In some implementations, the first reservoir is disposed at a higher altitude than the second reservoir.

In some implementations, the system further includes a power source. In some implementations, the power source can also store energy created by the turbomachine.

### BRIEF DESCRIPTION OF DRAWINGS

Example features and implementations are disclosed in the accompanying drawings. However, the present disclosure is not limited to the precise arrangements and instrumentalities shown.

FIG. 1A is a perspective view of a rim-drive turbomachine, according to one implementation.

FIG. 1B is a cross-sectional view of the rim-drive turbomachine of FIG. 1A as viewed from line 1B-1B.

FIG. 2 is a perspective view of a rim-drive turbomachine, according to another implementation.

FIG. 2A is a cross-sectional view of the rim-drive turbomachine of FIG. 2 as viewed from line 2A-2A.

FIG. 3 is a cross-sectional view of a rim-drive turbomachine, according to another implementation.

FIG. 4 is a side view of a rim-drive system including the rim-drive turbomachine of FIG. 1A.

### DETAILED DESCRIPTION

The devices, systems, and methods described herein include a reversible rim-drive turbomachine that can operate efficiently as either a pump or a turbine. For example, various implementations of the turbomachine are adaptable to a wide range of lower head pressure small scale sites with minimal infrastructure or civil works required. The widespread availability of these existing sites removes much of the initial capital costs and extensive permitting. Various implementations of the rim-drive turbomachine allow the inlet and exit flow paths to be simple pipes, while the open centerline allows the turbomachine to be tolerant to foreign object ingestion. This turbomachine lends itself well to a distributed model of pumped storage hydropower (“PSH”), taking advantage of many existing sites suitable for small reservoirs with smaller elevation changes. The turbomachine is also more effective at damping fluctuations in power production (on the order of several hours) generated by wind and solar, compared to existing large scale PSH with cycle times on the order of 24 hours aimed at providing spinning reserve during on-peak hours and operating as an energy sink during off-peak hours. Various implementations of this turbomachine allow for a large number of small scale (100 kW-10 MW) PSH plants that are distributed into the grid and operate at faster cycle times (2 or more times per day).

The devices, systems, and methods described herein can include a small scale distributed modular PSH turbomachine. The small scale distributed modular PSH turbomachine takes advantage of (1) readily available low head pressure sites (10-100 meters of H₂O of head pressure), (2) economies of scale from mass producing modular flexible PSH components (pumps/turbines) reducing per-unit costs, and (3) the certification process for mass produced similar sites/systems to reduce risk and time to deployment (i.e., similar to wind turbine industry).

The rim-drive turbomachines disclosed herein include modular shell portions that can be used as either a pump or a turbine. Each of the shell portions include a set of blades. Some of the sets of blades are rotatably coupled to a motor rotor that is driven by a motor stator. The different sets of blades are controlled independently to maximize the efficiency of the turbomachine for a given flow rate of a fluid through the turbomachine when the turbomachine is used as a pump. By being able to modularly combine additional shell portions and sets of blades, the turbomachine provides flexibility and scalability. The hub-less modular design provides for a high efficiency over a broad range of flow rates, low head pressure, and variable flow energy extraction.

The inner ends of the blades of each of the sets of blades are radially spaced apart from the central axis to define an aperture. The blades are angled and shaped to cause any debris or other solid material in the fluid to be forced toward the aperture such that the debris or other solid material can pass through the aperture and not obstruct the blade set.

The proposed turbomachine is intended for distributed energy storage in the 100 kW to 10 MW power range. The relatively low-head and small scale allows this turbomachine to take advantage of many existing reservoir sites with additional uses and benefits. This turbomachine has the potential to significantly alter each of the four identified significant PSH limitations. FIG. 4 shows an example overview of how this turbomachine would work. Integrating PSH with additional reservoirs provides new siting opportunities and provides additional revenue streams. The variability in the cost of energy is less of an issue for return on investment with this turbomachine as well. Distributing PSH systems and integrating with existing variable renewable energy systems, such as nearby wind or solar, would not only provide increased reliability, but would also allow providers to better match energy production with energy price.

Various implementations include a rim-drive turbomachine. The turbomachine includes a hollow cylindrical shell, at least one motor rotor, at least one motor stator, and N sets of blades. The hollow cylindrical shell has an inner surface and a central axis. The shell includes S shell portions, wherein S equals two or more. Each of the S shell portions is axially separate from each of the other shell portions, and each of the S shell portions are axially couplable to the other shell portions. The at least one motor rotor is coupled to the inner surface of one of the S shell portions and extends circumferentially around the central axis. The at least one motor rotor is rotatable about the central axis and relative to the shell. The at least one motor stator is in electromagnetic communication with the at least one motor rotor. The N sets of blades equals two or more sets of blades. Each of the S shell portions has at least one of the N sets of blades coupled to the inner surface of that shell portion. Each of the N sets of blades extends radially inwardly toward the central axis. The blades of each of the N sets of blades are spaced circumferentially around the central axis. Each of the N sets of blades is axially spaced apart along the central axis from each of the other sets of blades. A single set of N blades is coupled to the at least one motor rotor.

Various other implementations include a rim-drive system. The system includes a rim-drive turbomachine, a first reservoir, and a second reservoir. The hollow cylindrical shell of the turbomachine has a central axis, a first end, a second end opposite and spaced apart along the central axis from the first end, and an inner surface extending between the first and second ends. The first reservoir is for containing fluid and is fluidically coupled to the first end of the shell. The second reservoir is for containing fluid and is fluidically coupled to the second end of the shell.

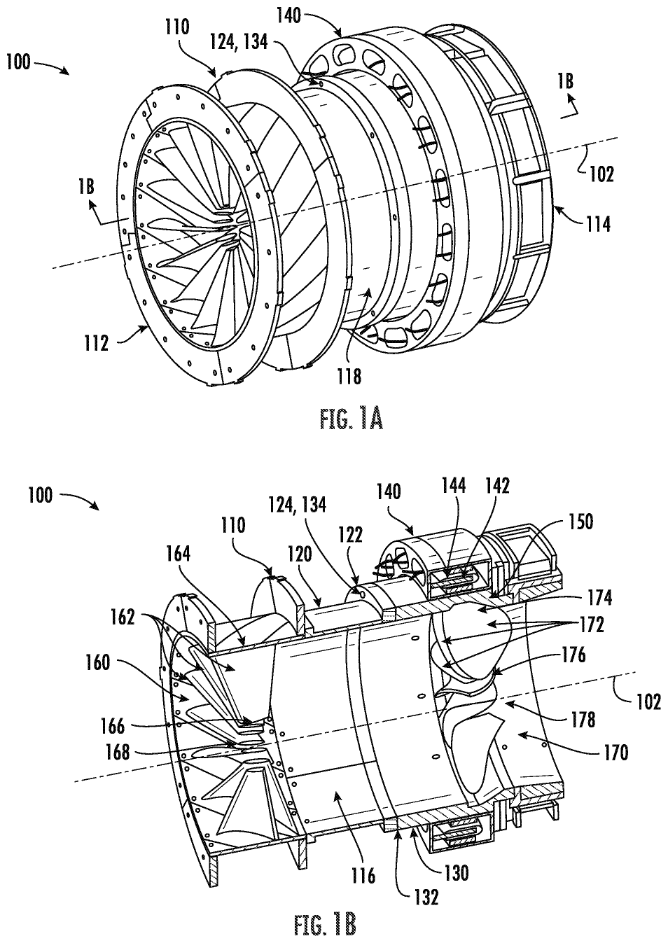

FIGS. 1A and 1B show a rim-drive turbomachine 100 according to one implementation. The turbomachine 100 includes a shell 110, a motor stator 140, a motor rotor 150, a set of non-rotational blades 160 and a set of rotor blades 170.

The shell 110 is a hollow cylindrical body having a central axis 102. The shell has a first end 112 and a second end 114 opposite and spaced apart from the first end 112 along the central axis 102. The shell 110 also has an inner surface 116 extending between the first end 112 and the second end 114 and an outer surface 118 spaced radially outwardly from the inner surface 116.

As shown in FIG. 1B, the shell 110 is formed from a first shell portion 120 and a separately formed second shell portion 130. The first shell portion 120 and the second shell portion 130 each have a flange 122, 132 extending radially outwardly from an axial end of each portion 120, 130. Each of the flanges 122, 132 define a plurality of fastener openings 124, 134. The first and second shell portions 120, 130 are disposed such that the flanges of the first and second shell portions 122, 132 abut each other and the fastener openings 124 of the first shell portion 120 are aligned with the fastener openings 134 of the second shell portion 130. The first shell portion 120 is coupled to the second shell portion 130 by bolts extending through the aligned fastener openings 124, 134.

The motor stator 140 shown in FIGS. 1A and 1B is coupled to the outer surface 118 of the shell that corresponds to the second shell portion 130 such that the motor stator 140 is non-rotatable relative to the shell 110. As used herein, the term “motor stator” refers to the non-rotational portion of the electromagnetic system of a motor or generator and does not include any shell portions that are coupled to the motor stator. The motor stator 140 includes an annular core 142 extending around the central axis 102 and a series of windings extending around the annular core 142 to form stator coils 144.

The motor rotor 150 is an annular, ferromagnetic body that extends circumferentially around the central axis 102. As used herein, the term “motor rotor” refers to the rotational portion of the electromagnetic system of a motor or generator and does not include any blades that are coupled to the motor rotor. The motor rotor 150 is rotatably coupled to the second shell portion 130 such that the motor rotor 150 is rotatable relative to the shell 110 and the motor stator 140 about the central axis 102. The motor rotor 150 is in electromagnetic communication with the motor stator 140 such that an electrical charge flowing through the stator coils 144 causes the circumferential rotation of the motor rotor 150 about the central axis 102.

In some implementations, the motor rotor and motor stator are a Halbach array generator design. The turbomachine can include a double-sided motor rotor with a motor stator. The motor stator can include “racetrack” windings that form a 6-phase Gramme winding.

The first set of non-rotational blades 160 is coupled to the first shell portion 120 and is non-rotatable relative to the shell 110. Different industries sometimes refer to these non-rotational blades 160 by other terms, such as vanes (e.g., inlet, outlet, guide, de-swirl, pre-swirl, or recovery), gates (e.g., wickets), nozzles, or diffusors. Each non-rotational blade 162 in the first set of non-rotational blades 160 has an outer end 164 coupled to the inner surface 116 of the first shell portion 120 and an inner end 166 opposite and radially inwardly spaced apart from the outer end 164. Each of the inner ends 166 is radially spaced apart from the central axis 102 to define an aperture 168 through which the central axis 102 extends. Each non-rotational blade 162 in the first set of non-rotational blades 160 is circumferentially spaced apart from the other non-rotational blades in the first set of non-rotational blades 160, and an angle of incidence of each non-rotational blade 162 is angled between zero and ninety degrees relative to the central axis 102. The angled, non-rotational first set of non-rotational blades 160 act as inlet guide vanes to cause fluid flowing axially through the shell 110 to rotate or swirl circumferentially in the rotational direction of the second set of rotor blades 170.

The second set of rotor blades 170 is coupled to the motor rotor 150, which is rotatably coupled to the second shell portion 130. Different industries sometimes refer to these rotor blades 170 by other terms, such as impeller or runner blades. Each rotor blade 172 in the second set of rotor blades 170 has an outer end 174 coupled to the motor rotor 150 and an inner end 176 opposite and radially inwardly spaced apart from the outer end 174. Each of the inner ends 176 are radially spaced apart from the central axis 102 to define an aperture 178 through which the central axis 102 extends. Each rotor blade 172 in the second set of rotor blades 170 is circumferentially spaced apart from the other rotor blades in the second set of rotor blades 170, and the angle of incidence of each rotor blade 172 is angled between zero and ninety degrees relative to the central axis 102.

Each of the non-rotational blades 162 of the first set of non-rotational blades 160 and each of the rotor blades 172 of the second set of rotor blades 170 can be made using additive manufacturing (e.g., high power laser additive manufacturing) to provide economical design optimization through iterative prototyping and fully customizable or configurable designs. In some implementations, hybrid processing (e.g., additive manufacturing and subtractive manufacturing) is utilized for fabrication of the first set of non-rotational blades 160 and second set of rotor blades 170. Near-net shape forms can be created with the additive manufacturing process then subtractive machining can be used to produce the final part geometry.

When the turbomachine 100 is operating as a turbine, fluid flowing axially through the shell 110 contacts the angled rotor blades 172 in the second set of rotor blades 170, causing the rotation of the second set of rotor blades 170 relative to the central axis 102. The rotation of the second set of rotor blades 170 causes the motor rotor 150 to rotate and induce an electrical current through the motor stator 140.

When the turbomachine 100 is operating as a pump, electrical energy flows through the motor stator 140 to rotate the motor rotor 150, which causes the rotation of the second set of rotor blades 170 relative to the central axis 102. The rotation and angle of each of the rotor blades 172 in the second set of rotor blades 170 causes fluid to flow axially through the shell 110.

The shape of each of the non-rotational blades 162 of the first set of non-rotational blades 160 and each of the rotor blades 172 of the second set of rotor blades 170 are angled and shaped to force any debris or other solid matter within the fluid toward their respective apertures 168, 178. The angle of incidence of each non-rotational blade 162 and rotor blade 172 is angled between zero and ninety degrees relative to the central axis 102 and curved along the radial direction such that the blades' relative camber angle and angle of attack cause a pressure differential between the fluid adjacent the inner surface 116 of the shell 110 and the fluid adjacent the inner ends of the non-rotational blades 166 and rotor blades 176.

When the second set of rotor blades 170 are rotated or the fluid flows past either set of blades 160, 170, the shape of the blades 162, 172 causes a higher pressure within the fluid adjacent the inner surface 116 of the shell 110 than the fluid adjacent the central axis 102. This pressure differential causes the fluid to flow from the areas of high pressure near the inner surface 116 toward the areas of low pressure near the aperture 178. The radially inward flow of fluid within the turbomachine 100 moves any debris or other solid matter toward the aperture 178 to clean the sets of rotor blades 170. The debris or other solid matter can then pass through the aperture 178 and out of the shell 110.

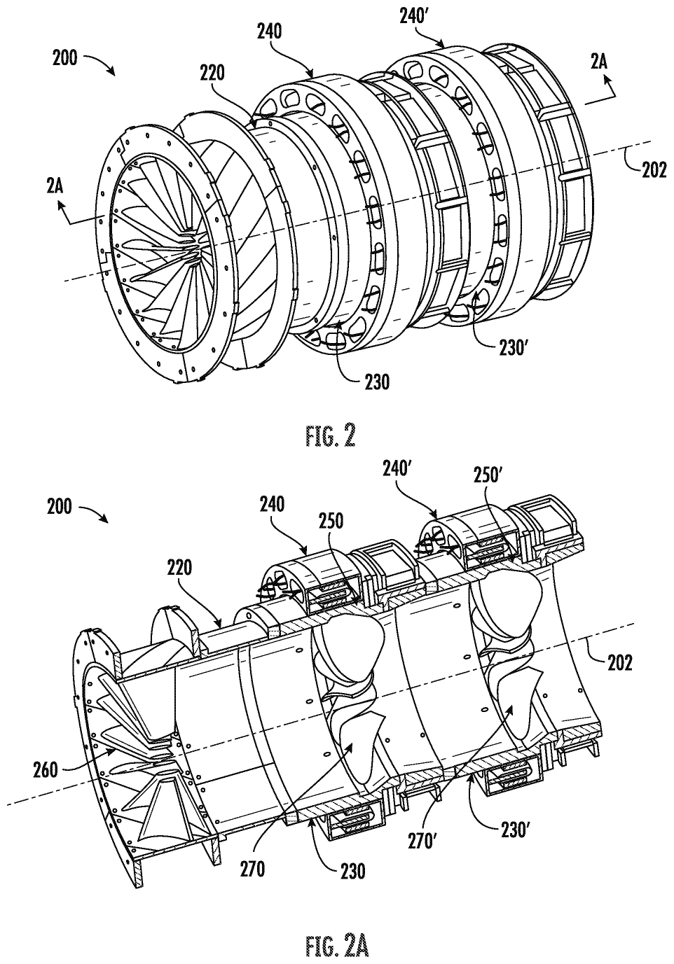

Although the rim-drive turbomachine 100 shown in FIGS. 1A and 1B includes two shell portions 120, 130, a set of non-rotational blades 160, a set of rotor blades 170, one motor rotor 150, and one motor stator 140, in some implementations, the turbomachine includes any number of shell portions, sets of non-rotational blades, sets of rotor blades, motor rotors, and motor stators. The modular nature of the turbomachines disclosed herein allow for various configurations of shell portions, sets of non-rotational blades, sets of rotor blades, motor rotors, and motor stators based on need. FIGS. 2 and 2A show an implementation of a rim-drive turbomachine 200 similar to the turbomachine 100 shown in FIG. 1A, but with three shell portions, one set of non-rotational blades, two sets of rotor blades, two motor rotors, and two motor stators. The first shell portion 220 is coupled to the second shell portion 230, and the second shell portion 230 is coupled to the third shell portion 230′. The first motor stator 240 and first motor rotor 250 are coupled to the second shell portion 220, and the second motor stator 240′ and second motor rotor 250′ are coupled to the third shell portion 230′. As shown in FIG. 2A, the first set of non-rotational blades 260 is non-rotatably coupled to the first shell portion 220, the second set of rotor blades 270 is coupled to the first motor rotor 250, and the third set of rotor blades 270′ is coupled to the second motor rotor 250′.

In other implementations, the shell includes S shell portions, wherein S equals two or more shell portions. Each of the S shell portions are axially separate from each of the other shell portions, and each of the S shell portions are axially couplable to the other shell portions. In some implementations, the shell is sized to be disposed within a pipe.

In some implementations, the motor stator is coupled to the inner surface of the shell. In some implementations, the turbomachine includes R motor rotors and R motor stators, wherein R equals one or more motor rotors and motor stators. In some implementations, each motor stator is coupled to a different shell portion. In some implementations, two or more motor stators are coupled to one or more of the shell portions. In some implementations, the R motor stators and motor rotors are rotated and controlled together. In some implementations, the R motor stators and motor rotors are separately rotatable and controllable.

In some implementations, each set of blades has a permanent magnet rim-drive motor stator/motor rotor configuration, allowing for the speed and direction of each set of blades to be controlled independently. In these implementations, a stationary set of blades is a special case with an RPM of zero. A key advantage of this configuration is that this configuration provides the flexibility to operate efficiently (i.e., with each blade row seeing the designed relative velocity at the incidence angle) over a very large range of operating conditions as either a pump or turbine. This flexibility allows the turbomachine to operate as a pump or turbine at reasonable efficiencies to accommodate operation under significantly different hydrodynamic conditions.

The modular design of the turbomachines discussed herein allow for different combinations of the number of shell portions and the number of rotatable and non-rotatable blades coupled to the shell portions. For example, in some implementations, the turbomachine includes N sets of blades, wherein N equals two or more sets of blades. The N sets of blades can include any number of sets of non-rotational blades or rotor blades. Each of the S shell portions has at least one of the N sets of blades coupled to the inner surface of that shell portion. However, in other implementations, at least one of the S shell portions does not have one of the N sets of blades coupled to it. And, in other implementations, one or more of the S shell portions has two or more of the N sets of blades coupled to it. In some implementations, at least one of the N sets of blades is non-rotatably coupled to one or more of the S shell portions.

In some implementations, each of the N sets of blades is coupled to a motor rotor.

In some implementations, the turbomachine has an equal number of S shell portions and N sets of blades.

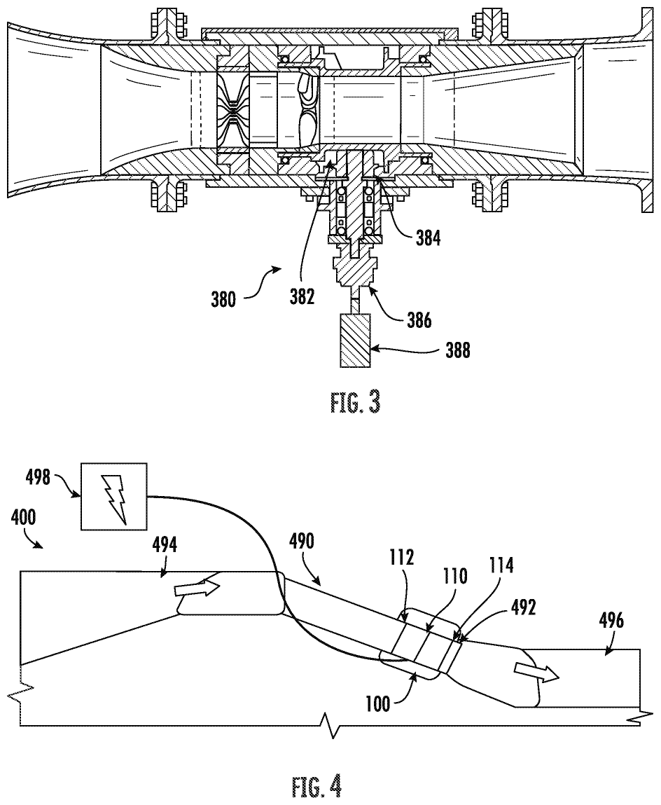

FIG. 3 shows another implementation of a rim-drive turbomachine 300 similar to the turbomachine 100 shown in FIGS. 1A and 1B, but the implementation of the turbomachine 300 shown in FIG. 3 includes a gear drive 380 instead of a motor stator and a motor rotor. The gear drive 380 includes a ring gear 382, a bevel gear 384, a planetary speed reducer 386, and a motor 388. The motor 388 is coupled to the planetary speed reducer 386, which is coupled to the bevel gear 384. The ring gear 382 is coupled to the second set of rotor blades 370 in a similar way as the motor rotor 150 is coupled to the second set of rotor blades 170 in the implementation of the turbomachine 100 shown in FIGS. 1A and 1B. The teeth of bevel gear 384 and the teeth of the ring gear 382 mesh together such that movement from the motor 388 causes the second set of rotor blades 370 to rotate.

FIG. 4 shows a rim-drive system 400 according to one implementation. The system 400 includes a rim-drive turbomachine 100 as described herein, along with a first pipe 490, a second pipe 492, a first reservoir 494, a second reservoir 496, and a power source 498.

The first pipe 490 is fluidically coupled to the first end 112 of the shell 110 of the turbomachine 100, and the second pipe 492 is fluidically coupled the second end 114 of the shell 110. The first pipe 490 is in fluid communication with the first reservoir 494, and the second pipe 492 is in fluid communication with the second reservoir 496. The power source 498 is in electrical communication with the turbomachine 100 to provide electrical current to the motor stator 140 for rotating the motor rotor 150 and second set of rotor blades 170 when the turbomachine 100 is used as a pump. However, the power source 498 can also store energy created by fluid rotating the second set of rotor blades 170 and motor rotor 150 to induce a current in the motor stator 140 when the turbomachine 100 is used as a turbine.

In FIG. 4, the first reservoir 494 is disposed at a higher altitude than the second reservoir 496. When the turbomachine 100 is used as a pump, the rotation of the second set of rotor blades 170 in the turbomachine 100 causes fluid from the second reservoir 496 to flow through the second pipe 492, through the turbomachine 100, through the first pipe 490, and into the first reservoir 494. When the turbomachine 100 is used as a turbine, gravity causes the fluid in the first reservoir 494 to flow through the first pipe 490, through the turbomachine 100, through the second pipe 492 and into the second reservoir 496. As the fluid flows through the turbomachine 100, the fluid causes rotation of the set of rotor blades 170 and motor rotor 150 which induces a current in the motor stator 140. The first set of non-rotational blades 160 that is non-rotatable relative to the shell of the turbomachine 100, and are closer than the other sets of blades to the first end of the shell 112, acts as inlet guide veins to cause the incoming fluid to begin rotating as it passes through the turbomachine 100.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A rim-drive turbomachine, the turbomachine comprising:
a hollow cylindrical shell having an inner surface and a central axis, the shell including S shell portions, wherein S equals two or more, each of the S shell portions being axially separate from each of the other shell portions, and each of the S shell portions are axially couplable to the other shell portions;
at least one motor rotor coupled to the inner surface of one of the S shell portions and extending circumferentially around the central axis, wherein the at least one motor rotor is rotatable about the central axis and relative to the shell;
at least one motor stator in electromagnetic communication with the at least one motor rotor; and
N sets of blades, wherein N equals two or more, wherein each of the S shell portions has at least one of the N sets of blades coupled to the inner surface of that shell portion, each of the N sets of blades extending radially inwardly toward the central axis, wherein the blades of each of the N sets of blades are spaced circumferentially around the central axis, each of the N sets of blades being axially spaced apart along the central axis from each of the other sets of blades,
wherein a single set of N blades is coupled to the at least one motor rotor.

2. The turbomachine of claim 1, wherein each of the blades has an outer end coupled adjacent the inner surface and an inner end that is spaced radially inward of the outer end,
wherein the inner ends of the blades are spaced apart from the central axis and define an aperture through which the central axis extends.

3. The turbomachine of claim 1, wherein one of the N sets of blades is stationary with respect to the shell.

4. The turbomachine of claim 1, the turbomachine further comprising R motor rotors coupled to the inner surface of the shell and extending circumferentially around the central axis and R motor stators, each of the R motor stators being in electromagnetic communication with one of the R motor rotors,
wherein one of the R motor rotors is rotatable relative to the shell, and the second set of blades is coupled to the second motor rotor, and
wherein each of the R motor rotors is independently rotatable from the other motor rotors.

5. (canceled)

6. The turbomachine of claim 1, wherein the one set of blades are shaped such that, when the one set of blades are rotated, the one set of blades causes a higher pressure of a fluid inside the shell adjacent the inner surface of the shell than adjacent the central axis.

7. The turbomachine of claim 1, wherein the shell is configured to be disposed within a pipe and has an outer surface radially spaced apart from the inner surface, and the motor stator is coupled to the outer surface of the shell.

8. (canceled)

9. The turbomachine of claim 1, wherein the turbomachine is usable as a turbine or a pump.

10. (canceled)

11. The turbomachine of claim 1, wherein S is equal to N.

12. A rim-drive system, the system comprising:
a rim-drive turbomachine, the turbomachine comprising:
a hollow cylindrical shell having a central axis, a first end, a second end opposite and spaced apart along the central axis from the first end, and an inner surface extending between the first and second ends, the shell including S shell portions, wherein S equals two or more, each of the S shell portions being axially separate from each of the other shell portions, and each of the S shell portions are axially couplable to the other shell portions;
at least one motor rotor coupled to the inner surface of one of the S shell portions and extending circumferentially around the central axis, wherein the at least one motor rotor is rotatable about the central axis and relative to the shell;
at least one motor stator in electromagnetic communication with the at least one motor rotor; and
N sets of blades, wherein N equals two or more, wherein each of the S shell portions has at least one of the N sets of blades coupled to the inner surface of that shell portion, each of the N sets of blades extending radially inwardly toward the central axis, wherein the blades of each of the N sets of blades are spaced circumferentially around the central axis, each of the N sets of blades being axially spaced apart along the central axis from each of the other sets of blades,
wherein a single set of N blades is coupled to the at least one motor rotor;
a first reservoir for containing fluid, the first reservoir being fluidically coupled to the first end of the shell; and
a second reservoir for containing fluid, the second reservoir being fluidically coupled to the second end of the shell.

13. The system of claim 12, wherein each of the blades has an outer end coupled adjacent the inner surface and an inner end that is spaced radially inward of the outer end, wherein the inner ends of the blades are spaced apart from the central axis and define an aperture through which the central axis extends.

14. The system of claim 12, wherein one of the N sets of blades is stationary with respect to the shell, and
wherein the one set of blades that is stationary with respect to the shell is closer than the other sets of blades to the first end of the shell.

15. The system of claim 12, the turbomachine further comprising R motor rotors coupled to the inner surface of the shell and extending circumferentially around the central axis and R motor stators, each of the R motor stators being in electromagnetic communication with one of the R motor rotors,
wherein one of the R motor rotors is rotatable relative to the shell, and the second set of blades is coupled to the second motor rotor, and
wherein each of the R motor rotors is independently rotatable from the other motor rotors.

16. (canceled)

17. The system of claim 12, wherein the one set of blades are shaped such that, when the one set of blades are rotated, the one set of blades causes a higher pressure of a fluid inside the shell adjacent the inner surface of the shell than adjacent the central axis.

18. The system of claim 12, wherein the shell has an outer surface radially spaced apart from the inner surface, and the motor stator is coupled to the outer surface of the shell.

19. (canceled)

20. The system of claim 12, wherein the turbomachine is usable as a turbine or a pump.

21. (canceled)

22. The system of claim 12, wherein S is equal to N.

23. The system of claim 12, further comprising:
a first pipe fluidically coupling the first reservoir to the first end of the shell; and
a second pipe fluidically coupling the second reservoir to the second end of the shell.

24. (canceled)

25. The system of claim 12, wherein the first reservoir is disposed at a higher altitude than the second reservoir.

26. (canceled)

27. The system of claim 12, further comprising a power source configured to store energy created by the turbomachine.

28. (canceled)

29. A rim-drive turbomachine comprising:
a hollow cylindrical shell defining a central axis, the shell including a plurality of axially separated shell portions configured to be coupled together, each of the shell portions defining an inner surface;
a motor rotor coupled to the inner surface of at least on shell portion, extending circumferentially about the central axis, and rotatable about the central axis and relative to the shell;
a motor stator in electromagnetic communication with the motor rotor; and
a plurality of sets of blades spaced axially from one another along the central axis, wherein each of the shell portions has at least one set of blades coupled to the inner surface of that shell portion,
wherein each set of blades extends radially inwardly toward the central axis, wherein each set of blades includes blades that are spaced circumferentially about the central axis, and
wherein a single set of blades is coupled to the motor rotor.
